(19) United States
(12) Patent Application Publication
(10) Pub. No.: US 2021/0270238 A1
(43) Pub. Date: Sep. 2, 2021

(54) ROTARY MACHINE CONTROL SYSTEM

(71) Applicant: Westinghouse Air Brake Technologies Corporation, Pittsburgh, PA (US)

(72) Inventors: Carl L. Haas, Walkersville, MD (US); Mark Uehling, Germantown, MD (US)

(21) Appl. No.: 17/112,617

(22) Filed: Dec. 4, 2020

Related U.S. Application Data
(60) Provisional application No. 62/943,906, filed on Dec. 5, 2019.

(51) Int. Cl. F03D 9/25; F03D 9/32

(52) U.S. Cl. CPC F03D 9/25; F03D 9/32; F05B 2260/903; F05B 2210/12; F05B 2270/1014; F05B 2210/11

(57) ABSTRACT

A rotary machine includes a stator and a rotor that rotates relative to the stator in response to flow of a fluid by or through the rotor. The rotary machine also includes a control circuit configured to determine one or more operational characteristics of the electric machine. The one or more operational characteristics are indicative of a flow of the fluid or a load placed on the rotary machine, the control circuit configured to apply control signals to control one or more switches of the rotary machine to induce a magnetic field in the rotary machine that resists a force imparted on a rotor of the rotary machine from the flow of the fluid. The control signals control the one or more switches of the rotary machine to control a speed at which the rotor rotates.

### CROSS-REFERENCE TO RELATED APPLICATIONS

This application claims priority to U.S. Provisional Application No. 62/943,906, which was filed on 5 Dec. 2019, and the entire disclosure of which is incorporated herein by reference.

### BACKGROUND

### Technical Field

The subject matter described herein relates to control systems for rotary machines such as turbine generators.

### Discussion of Art

Rotary machines can be used to convert movement of a fluid into electric energy, such as voltage and/or current. For example, the flow of air through a turbine can rotate turbine blades, which rotate a rotor of the turbine relative to a stator of the turbine. This rotation can be used to inductively induce electric current by converting the rotation or the rotor relative to the stator into the electric energy.

The amount of electric energy generated by the rotary machine can depend on characteristics of the flow at which the fluid moves through the rotary machine. Faster flow rates and/or greater fluid pressures can generate more electric energy while slower rates and/or smaller fluid pressures can generate less electric energy. Some rotary machines can be used in environments where the flow of a fluid through the rotary machine varies over time. For example, the rate and/or pressure at which air or other fluids flow through a turbine can change with respect to time. This can result in the rotary machines creating varying amounts of electric energy. Additionally, the load placed on the rotary machines by one or more other devices (e.g., one or more electric loads) can change with respect to time and may not precisely coincide with the amount of electric energy generated with respect to time.

For example, an air turbine provides torque from flow of air through the turbine regardless of the opposing torque provided by a generator (having a rotor that is rotated by the turbine). While there is a load on the generator (e.g., the generator is supplying current to power a load), the generator creates torque that opposes rotation of the rotor in the turbine. But, when there is a reduced or no load on the generator, the generator may provide too small of an opposing torque. As a result, the turbine can overspeed (e.g., rapidly rotate), which can lead to increased wear and tear, and may result in premature failure of the system.

Some rotary machines are used in connection with resistors to increase the opposing torque provided by the generator on the turbine to prevent over speed. But, these resistors generate heat when current flows through the resistors. This heat may need to be dissipated without interfering with or damaging other components of the system.

### BRIEF DESCRIPTION

As one example, a method includes determining one or more operational characteristics of a generator that is coupled with a rotary machine and that generates electric energy from flow of fluid through the rotary machine. The method also includes applying control signals to control one or more switches of the rotary machine to induce a magnetic field in the rotary machine that resists a force imparted on a rotor of the rotary machine from the flow of the fluid. The control signals control the one or more switches of the rotary machine to control operation of the rotary machine and effect a change in the one or more operational characteristics.

As another example, a rotary machine includes a stator and a rotor that rotates relative to the stator in response to flow of a fluid by or through the rotor. Rotation of the rotor relative to the stator induces an electric current that is conducted via the one or more stator windings. The rotary machine also includes a control circuit configured to determine one or more operational characteristics of the electric machine. The one or more operational characteristics are indicative of a flow of the fluid or a load placed on the rotary machine, the control circuit configured to apply control signals to control one or more switches of the rotary machine to induce a magnetic field in the rotary machine that resists a force imparted on a rotor of the rotary machine from the flow of the fluid. The control signals control the one or more switches of the rotary machine to control a speed at which the rotor rotates.

In another example, a power generator system includes a rotary machine including a rotor and a stator that generates electric current in response to flow of a fluid by or through the rotor. The rotary machine includes phased outputs that conductively coupled the rotary machine to one or more loads for supplying the electric current to power the one or more loads. The system also includes a control circuit configured to determine one or more of a varying flow of the fluid or a varying current demand placed on the rotary machine by the one or more loads. The control circuit is configured to apply control signals to one or more switches of the rotary machine to induce a magnetic field in the rotary machine that resists rotation of the rotor to control a speed at which the rotor rotates independent of the one or more of the varying flow of the fluid through the rotary machine or the varying load placed on the rotary machine.

### BRIEF DESCRIPTION OF THE DRAWINGS

The inventive subject matter may be understood from reading the following description of non-limiting embodiments, with reference to the attached drawings, wherein below:

FIG. 1 illustrates one example of a power generator system for a rotary machine;

FIG. 2 illustrates a circuit diagram of a control circuit shown in FIG. 1;

FIG. 3 illustrates examples of rotational speeds of a turbine generator shown in FIG. 1 as controlled by the control circuit also shown in FIG. 1;

FIG. 4 illustrates one example of an overspeed event of the turbine shown in FIG. 1; and

FIG. 5 illustrates a flowchart of one example method for controlling a rotary machine.

### DETAILED DESCRIPTION

Embodiments of the subject matter described herein relate to systems and methods that control operation of a rotary machine by changing electric current conducted through or within the rotary machine independent of output load current demand (e.g., the electric current that is demanded by one or more loads to be output by the rotary machine). The electric current conducted through or within the rotary machine can be increased independent of the current demanded by a load.

The outputs of the rotary machine can be coils of a generator. Movement of a rotor of the generator relative to a stator of the generator creates electric current in the coil(s) that is delivered to the load(s). This current can be referred to as a load current. As described herein, the rotary machine can be controlled to induce an extra or additional current that creates an opposing torque while the current is conducted within the coil(s) but not to the load(s). This extra or additional current can be conducted via extra or additional paths and may be activated for brief periods of time, such as 0.05 milliseconds. This additional current creates an opposing torque which can reduce the speed at which the generator (e.g., the rotor) rotates, which can reduce the power generated by the generator and reduce the speed at which the generator operates.

The time periods and/or frequencies at which the electric current conducted in the rotary machine is increased independent of load demand can be controlled using control signals, such as pulse wave modulation (PWM) signals or other methods to provide short duration pulses of additional current. These control signals may be synchronized with generator phases or may run independently. For some envisioned applications, the extra or additional current if continually active for a substantial amount of time, such as 5 seconds, would provide more braking effort than desired. For this reason, additional resistance elements may be needed to limit the current, and/or brief activations of the additional current repeated periodically could be used to achieve the desired braking effort. The on time and repetition period give a duty cycle which can be adjusted during operation for different levels of braking. For example, additional current pulsed for 0.05 milliseconds, repeated every 0.5 milliseconds would achieve a 10 percent duty cycle. Changing duty cycles of the control signals can control the speed and electric energy output or generated by the generator to match a demand from a load during times that the fluid flow through the generator is varying with respect to time and/or the load is varying with respect to time. This can prevent overspeed of the generator and increase the useful life span of the generator.

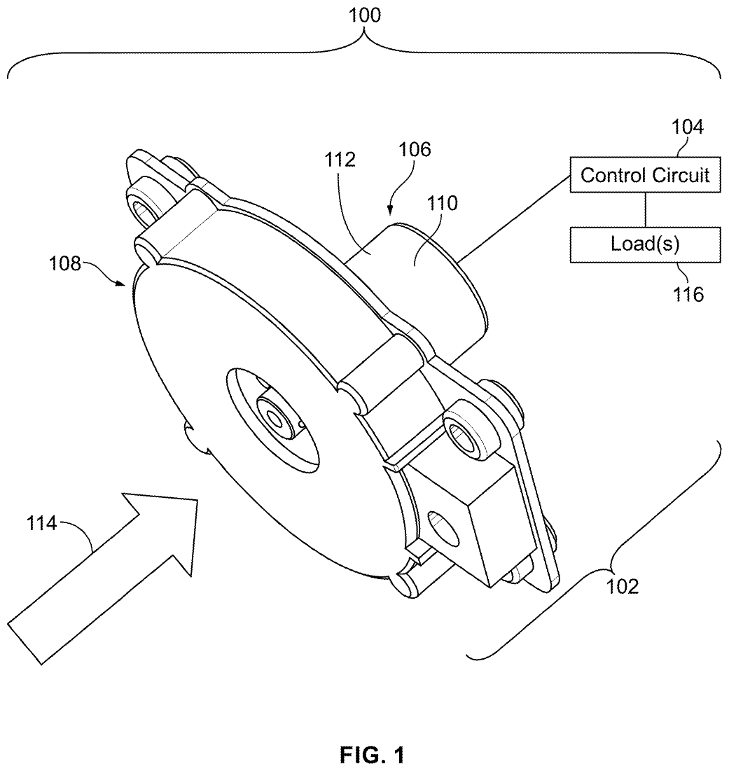

FIG. 1 illustrates one example of a power generator system 100 for a rotary machine 102. The system includes a control circuit 104 that is coupled with the rotary machine. The control circuit controls operation of the rotary machine, as described herein. The rotary machine can include a generator 106 coupled with a turbine 108. The generator can represent a device that converts rotary movement into electric energy, such as an induction generator, an alternator, or the like. The generator includes a rotor 110 that rotates relative to a stator 112. The rotor can include one or more magnets that induce current in conductive coils (not shown in FIG. 1) of the stator during rotation of the magnets relative to the coils. As used herein, the rotor includes the rotational part of the rotary machine (e.g., rotating magnets), but may not include the rotary inclined plane (e.g., a propeller) that is rotated from flow of the fluid. Alternatively, the rotor can represent both the rotational part and the rotary inclined plane.

Fluid 114 flows through the turbine to rotate the rotor, such as by rotating blades coupled with the rotor. In one example, the fluid is air. Optionally, the fluid can be another gas (e.g., engine exhaust, air mixed with engine exhaust, steam, or another type of gas) and/or a liquid (e.g., water, a lubricant such as oil, etc.). The generator inductively creates electric energy from rotation of the turbine, which can be supplied to one or more electric loads 116. These loads can represent propulsion devices of a vehicle (e.g., motors), monitoring devices (e.g., sensors), communication devices, auxiliary devices, hand-held power tools, energy storage devices (e.g., charging of batteries), or the like.

Based on the voltage that is output by the generator or other monitored parameter such as generator speed, the control circuit can increase an electric current conducted within one or more coils of the generator using control signals. This internal current of the generator can be increased or decreased independent of the output current demanded by a load. For example, the current conducted in the coils can be increased while the demanded current decreases, or the current conducted in the coils can be decreased while the demanded current increases. The control signals can dictate duty cycles by which a switch coupled to a coil closes (to cause additional current flow in the coil by providing another path for the current to flow separate from the load when the switch is activated). In addition to the switching device, this path may contain other electrical elements (resistor, capacitor, diode, etc.), or the switching device may be the only element in this additional path. Different control signals can be communicated to different switches to close or open the switches at during different time durations (e.g., time periods) and/or at different frequencies. These control signals can be PWM signals in one example. Optionally, the control signals may be signals other than PWM signals.

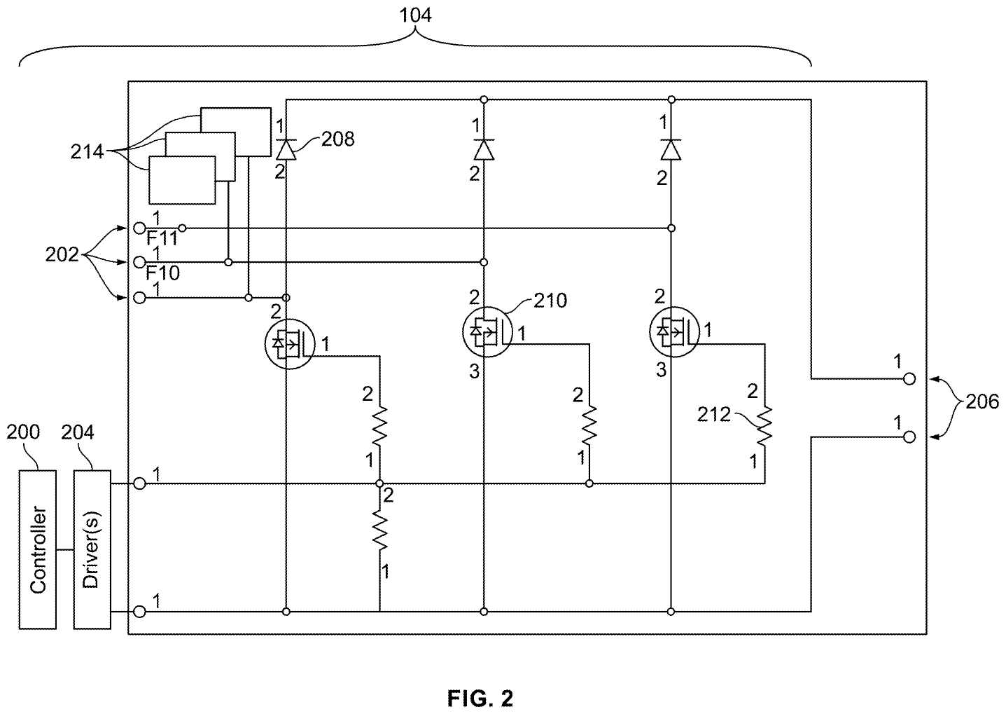

FIG. 2 illustrates a circuit diagram of an example implementation of the control circuit as part of a rectification circuit shown in FIG. 1. The control circuit includes a controller 200 that represents hardware circuitry that includes and/or is connected with one or more processors (e.g., one or more microprocessors, field programmable gate arrays, integrated circuits, etc.). The controller is coupled with several outputs 202 (e.g., outputs 202A-C) of the generator shown in FIG. 1 via one or more drivers 204 to control one or more switches 210. The switches optionally can be placed on the positive supply instead of or in addition to on the negative supply as shown. The switches are shown across the low sides of the diodes 208 (e.g., below the diodes in FIG. 2). Alternatively, the switches can be across the top three diodes shown in FIG. 2 with the ability to connect the phase terminals to the positive supply rail, or may connect the phase terminals with each other.

The outputs can represent coils of the generator and/or connections to the coils. For example, the outputs can represent the different coils through which different phases of the current produced by the generator are output to the rectification and control circuit. The current created by the generator is induced in one or more of the coils and is conducted to terminals or connectors 206 coupled with the loads via the control circuit (as shown in FIG. 2) when the switches are not closed.

The control circuit includes rectification diodes 208 that are conductively coupled with the outputs of the generator. Each diode is connected with a single, different output than the other diodes in the illustrated example. For example, each output can be coupled with the terminals or connectors of the load(s) by a different diode. The control circuit also includes switches 210 that are conductively coupled with the outputs of the generator. Optionally, as shown, rectification diodes may be included in the switches. The switches can represent field effect transistors, insulated gate bipolar transistors, or the like. As shown, each switch can be connected with a single, different output than the other switches and provides an alternate path for generator current when closed. The driver(s) are connected with gates of the switches. One or more resistive elements 212 (e.g., resistors) may be placed between the driver(s) and the gates of each of the switches. While three outputs, coils, diodes, and switches are shown to represent the generator creating a three-phase current for the load(s), optionally, the generator may have a single output, single coil, single diode, and/or single switch; two outputs, two coils, two diodes, and/or two switches; or more than three outputs, more than three coils, more than three diodes, and/or more than three switches. While the switches are shown to direct additional current through the negative terminal (or ground), the switches could alternatively be configured to direct additional current in other paths such as through the positive terminal or between phase outputs directly. While the switches are shown as the only element in the additional current path, additional elements (i.e. resistors, capacitors, inductors and the like) could also be in the path.

The one or more drivers control application of control signals to the switches. These control signals cause or direct the switches to open or close. For example, the drivers can represent one or more gate drives that apply voltages to gates of the switches to activate (or close) the switches. Application of the signal to a switch can cause the switch to close and cause an increase in current in the corresponding output of the generator. Removal of the signal from the switch can cause the switch to open (or deactivate) and resume normal path to the load.

In operation, the generator speed can be monitored and, based on this speed, the driver(s) apply the control signals to control or limit the speed at which the turbine rotates. The driver(s) can apply the control signals to the switches to keep the rotational speed of the turbine at a designated value or within a designated range of values (that is smaller than the maximum or rated range of rotational speeds of the turbine), even when the rate and/or pressure of the fluid flowing through the turbine changes. For example, the driver(s) can apply the control signals to keep the rotational speed of the turbine substantially the same (e.g., does not vary by more than 1%, by more than 3%, or by more than 5% in different embodiments) and/or to keep the rotational speed of the turbine within a defined window or range of speeds, even while the flow rate and/or pressure of the fluid flowing through the turbine changes (e.g., changes by more than 5%, by more than 10%, etc.). Additionally or alternatively, the driver(s) can apply the control signals to keep the rotational speed of the turbine substantially the same and/or to keep the rotational speed of the turbine within a defined window or range of speeds, even while the load placed on the generator by the load(s) changes (e.g., changes by more than 5%, by more than 10%, etc.). The range of speeds can change over time. For example, instead of the same window or range of speeds being used at all times, the window or range may be changed such that different windows or ranges are used at different times.

Closing switches causes current to be directed elsewhere (e.g. other than to the load). For example, while switches are open, electric current conducted through a coil can be conducted out of the corresponding outlet to the load. While switches are closed, however, the electric energy created by the generator is no longer conducted to the load and instead current flows locally.

Closing switches induces a temporary magnetic field in the rotary machine that resists a force imparted on the rotor of the rotary machine by the fluid. For example, applying a control signal to close all the switches induces a reverse magnetic field that opposes rotation of the turbine in the direction of rotation caused by flow of the fluid. Closing the switches for longer (e.g., increasing a duty cycle of the control signal) can cause the induced magnetic field to be applied for longer.

Fewer than all of the switches may be closed to activate the additional current in the generator, but closing only one of the switches may only induce the magnetic field that resists the force imparted on the rotor of the rotary machine by the fluid if the single switch is closed during the portion of the rotation where the phase output would normally be a positive voltage in the case of the FIG. 2 example. Therefore, closing less than all of the switches is possible but should be synchronized with phase outputs.

The controller can determine one or more operational characteristics of the turbine and regulate the control signals to restrict the speed at which the turbine is rotating and/or change another output characteristic (e.g., output voltage) based on the operational characteristic(s) that is or are determined. The operational characteristic(s) that is or are monitored can include one or more of an output voltage or voltage that is generated by the generator, a rotational speed of the rotor of the turbine or generator, an electric current that is output by the generator, an electric current that is conducted within one or more coils (or windings) of the generator, a flow rate of a fluid through the turbine, a pressure of the fluid flowing through the turbine, and/or a current demanded from the generator by the load(s) (e.g., a load placed on the rotary machine). As the rotational speed of the rotor of the turbine increases due to an increasing rate of fluid flow through the turbine and/or an increasing pressure of the fluid flowing through the turbine, the output voltage created by the generator may increase, the electric current output by the generator to the load may increase, and/or the electric current created and conducted within the coils of the generator may increase. As the rotational speed of the rotor of the turbine decreases due to a decreasing rate of fluid flow through the turbine and/or a decreasing pressure of the fluid flowing through the turbine, the output voltage created by the generator may decrease, the electric current output by the generator to the load may decrease, and/or the electric current created and conducted within the coils of the generator may decrease.

As one example, the controller can determine the operational characteristic via one or more sensors 214. Based on the operational characteristic that is determined, the controller can determine whether the speed of the turbine is increasing or decreasing, is faster than a threshold, or is slower than a threshold. The controller can determine operational characteristics that are not directly sensed by sensors 214. For example, if the output voltage is increasing, the controller can determine that the rotational speed of the turbine is increasing. Optionally, one or more speed sensors may report the speed of the turbine to the controller. The location of the sensors shown in FIG. 2 is provided as just one example. Alternatively, one or more of the sensors may be in a different location or position within the circuit or system. The controller can monitor the pressure of the fluid flowing through the turbine in a similar manner. For example, the controller can detect the electric energy generated by the rotary machine via the generator. Based on the measured energy, the controller can determine whether the pressure of the fluid is increasing or decreasing, is greater than a threshold, or is less than a threshold. For example, if the generated energy is increasing, the controller can determine that the fluid pressure is increasing and/or the load has changed. If the generated energy is decreasing, the controller can determine that the fluid pressure is decreasing and/or the load has changed. If the generated energy exceeds a threshold, the controller can determine that the fluid pressure is greater than a threshold pressure. This threshold can be empirically determined. If the generated energy does not exceed the threshold, the controller can determine that the fluid pressure is less than the threshold pressure. Optionally, one or more pressure sensors may report the pressure of the fluid to the controller.

The controller can monitor the load placed on the generator by the load(s) by monitoring operation of the load(s). For example, the controller can monitor the output current and/or voltage from the generator to determine changes in the load. Alternatively, the load(s) can communicate the demanded electric current to the controller. Optionally, the controller can communicate with the loads to monitor operation of the load(s) to determine changes in how many loads are operating (and therefore need current), the operational state of the loads (e.g., whether the loads are in standby mode or actively operating), etc.

Changes in the operational characteristic(s) that are monitored by the controller can indicate changes in the rotational speed of the turbine. The controller can direct the driver(s) to generate or change the control signals based on the operational characteristic(s). For example, responsive to the output voltage increasing or increasing above a threshold, the controller can direct the driver(s) to generate control signals that close one or more switches. The switch(es) can be closed for the same or different time periods (e.g., duty cycles) and/or alternate between open and closed states at the same or different frequencies. For example, for greater decreases in the output voltage, the controller may direct the driver(s) to generate the control signals to have switches closed or activated for longer.

As the operational characteristic of the turbine changes, the controller can change the control signals. For example, responsive to the rotational speed of the turbine increasing outside of a range of acceptable speeds (or moving toward exceeding an upper limit on the range), the controller can lengthen the duty cycle over which one or more switches are closed. As another example, responsive to the rotational speed of the turbine decreasing outside of a range of acceptable speeds (or moving toward exceeding a lower limit on the range), the controller can shorten the duty cycle over which one or more switches are closed.

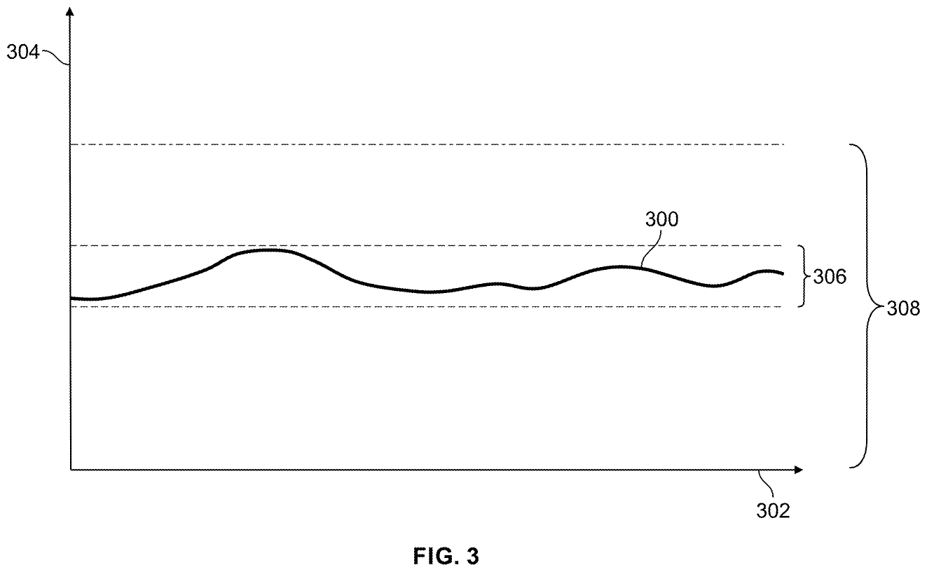

FIG. 3 illustrates examples of values 300 of an operational characteristic of the turbine shown in FIG. 1 as controlled by the control circuit also shown in FIG. 1. The operational characteristic values are shown alongside a horizontal axis 302 representative of time and a vertical axis 304 representative of increasing values of the operational characteristic. The operational characteristic can indicate or represent how fast the turbine is rotating. As shown, the operational characteristic values change over time due to changes in the fluid flowing through the turbine. The control circuitry directs generation of the control signals to keep the operational characteristic values (and therefore, the speed of the turbine) within a defined range or window 306. This defined window can keep the turbine and generator creating electric current within a defined range of magnitudes even if the rate and/or pressure of fluid flow through the turbine changes. Additionally, this defined window can be smaller (e.g., extend over a smaller range of speeds) than an entire operational range 308 of the turbine. Moreover, the size, upper limit, and/or lower limit of the window can change with respect to time. The operational range can represent the range of speeds that the turbine is designed or manufactured to operate within before failure is likely. Controlling the turbine to operate within the defined window may prevent the turbine from rotating at speeds approaching the upper or maximum limit on the turbine. This can extend the useful life of the turbine.

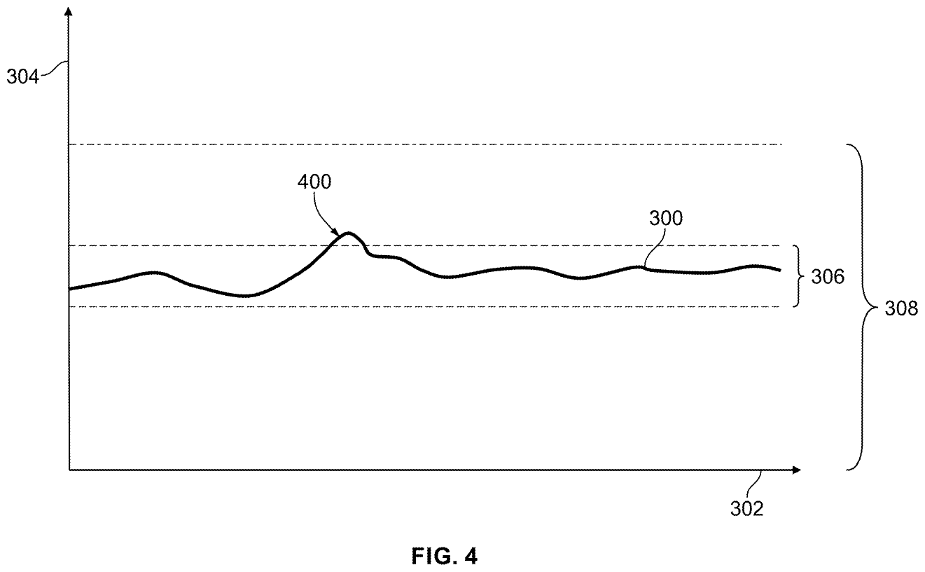

FIG. 4 illustrates one example of an overspeed event 400 of the turbine shown in FIG. 1. The rotational speed of the turbine may speed up and cause the operational characteristic to exceed the upper limit of the defined window. This may occur when the fluid flow rate and/or pressure suddenly and/or unexpectedly increases before the controller can detect the increase in speed and direct the driver(s) to generate the control signals to reduce the turbine speed. Responsive to detecting that the operational characteristic exceeds a threshold (e.g., the upper limit of the defined window), the controller can direct the driver(s) to change or begin creating the control signals to slow down the turbine speed to decrease or maintain the operational characteristic within the defined window, as described herein.

While changes in load and/or fluid flow through the turbine can cause the rotational speed of the turbine to change, the rotational speed of the turbine can change due to other causes or factors. For example, changes in temperature can cause components to expand or contract, which can slow down rotation of the rotary component due to increased friction (even if the load remains the same, the rate of fluid flow remains the same, and/or the pressure of the fluid flow remains the same). As another example, the health of bearings and/or lubricant in the rotary machine can impact how rapidly the rotary machine rotates. As the health of the bearings and/or lubricant decreases (e.g., due to age, improper maintenance, overuse, etc.), the rotary machine may not rotate as rapidly (even if the load remains the same, the rate of fluid flow remains the same, and/or the pressure of the fluid flow remains the same). Replacement of bearings and/or lubricant can increase the health of the bearings and/or lubricant, which can speed up rotation of the rotor (even if the load remains the same, the rate of fluid flow remains the same, and/or the pressure of the fluid flow remains the same). These factors can impact the allowable ranges or windows 306 of speeds. For example, in response to a change in temperature, decreasing health of bearings, and/or decreasing health of lubricant, the allowable speeds within the range 306 may be slower and/or the range 306 may decrease in size. It is also noted that for a given set of conditions, (fluid flow, load, and the like), the amount of PWM needed to maintain a given rotational speed may be used for diagnostic purposes. As an example, a decrease in the amount of PWM needed to maintain a given rotational speed may indicate the need to inspect the unit for bearing wear, etc.

Optionally, the allowable range of speeds can change based on location, time, regulations, ordinances, etc. Operation of the rotary machine can generate audible noise, and different locations, times of the day (or night), etc., may have different restrictions (e.g., regulations and/or ordinances) on the allowable audible noise that is generated. The allowable window of speeds of the rotary machine may decrease in speed and/or become a smaller range of speeds within certain locations (e.g., heavily populated areas) and then increase and/or become a larger range of speeds in other locations (e.g., more rural areas). The allowable window of speeds of the rotary machine may decrease in speed and/or become a smaller range of speeds during certain times (e.g., at night) and then increase and/or become a larger range of speeds in other locations (e.g., during daylight).

In one embodiment, the rotary machine shown in FIG. 1 may be disposed onboard a vehicle system. For example, the power generator system may be onboard a rail vehicle, automobile, truck, marine vessel, aircraft (manned, unmanned, or drone), agricultural vehicle, mining vehicle, or one or more other off-highway vehicles, to power one or more loads of the vehicle. With respect to rail vehicles, the power generator system can be used to power an end-of-train device onboard a rail vehicle system (e.g., a train). This end-of-train device can include sensors and communication devices to monitor brake pipe pressure, location, speed, etc., and communicate this information to other devices onboard the same vehicle system (e.g., an engine control unit of the rail vehicle system, an off-board location such as a back office system or server, etc.). These sensors and/or communication devices can be at least partially powered by the power generator system.

The turbine shown in FIG. 1 may represent or be replaced by a propeller, such as a propeller of a marine vessel. The generator shown in FIG. 1 may represent or be replaced by a motor that is coupled with the propeller. The controller can direct the drive(s) to generate and conduct the control signals the control circuitry. These signals short out the coils of the motor, as described above in connection with the generator. This allows for the controller to limit the speed at which the propeller is rotated (e.g., by flowing water). For example, the controller can short out different coils of the motor in response to changing flow of water through the propeller. This can allow the controller to control the propeller speed to within a designated range even while water is rapidly flowing, such as to brake or regeneratively brake the marine vessel. Optionally, the turbine shown in FIG. 1 may be placed into a conduit through which the fluid flows, such as a conduit through which oil, coolant, or the like, flows within a vehicle or other powered system.

When used in connection with a vehicle, the power generator system optionally can be referred to as a vehicle control system. For example, the rotary machine can include a traction motor as the generator and the turbine shown in FIG. 1 can be replaced by a wheel or axle that is connected with and rotated by the traction motor. During movement, the controller can determine (e.g., autonomously and/or based on operator input) to slow the vehicle. The controller can direct the traction motor to generate a braking effort on the wheel or axle similar to slowing rotation of the turbine in response to increasing rotation speeds, as described above. For example, the controller can direct the drive(s) to send control signals to the switches to induce temporary magnetic fields that resist rotation of the wheel or axle. This can brake and slow the vehicle similar to how the magnetic field slows rotation of the turbine in the power generator system.

With respect to aircraft, the turbine shown in FIG. 1 can be a turbine engine onboard an aircraft. The controller can control application of the control signals to control propulsion of the aircraft. For example, to slow propulsion of the aircraft (e.g., during landing), the controller can direct the control signals to be applied to generate the temporary magnetic fields and slow rotation of the blades or airfoils in the turbine engine, even though the air may be moving through the turbine engine at fast speeds. This can slow rotation of the blades to help reduce propulsion and slow movement of the aircraft. Optionally, the controller can direct application of the control signals such that the speed at which the turbine blades rotate remains the same or within a designated range of speeds even during varying flow conditions of the wind through the turbine engine.

The power generator system optionally can be used with a wind turbine. For example, the turbine shown in FIG. 1 can be a wind turbine that generates electric current by rotating the rotor of the generator also shown in FIG. 1. The controller can dictate generation of the control signals to prevent and/or reduce the duration of overspeed events of the wind turbine. This can decrease wear and tear on components of the wind turbine. Additionally, controlling the speed at which the wind turbine is allowed to rotate using the control signals can extend the range of operating speeds that the wind turbine can operate without having to change gearing or an orientation of blades of the wind turbine.

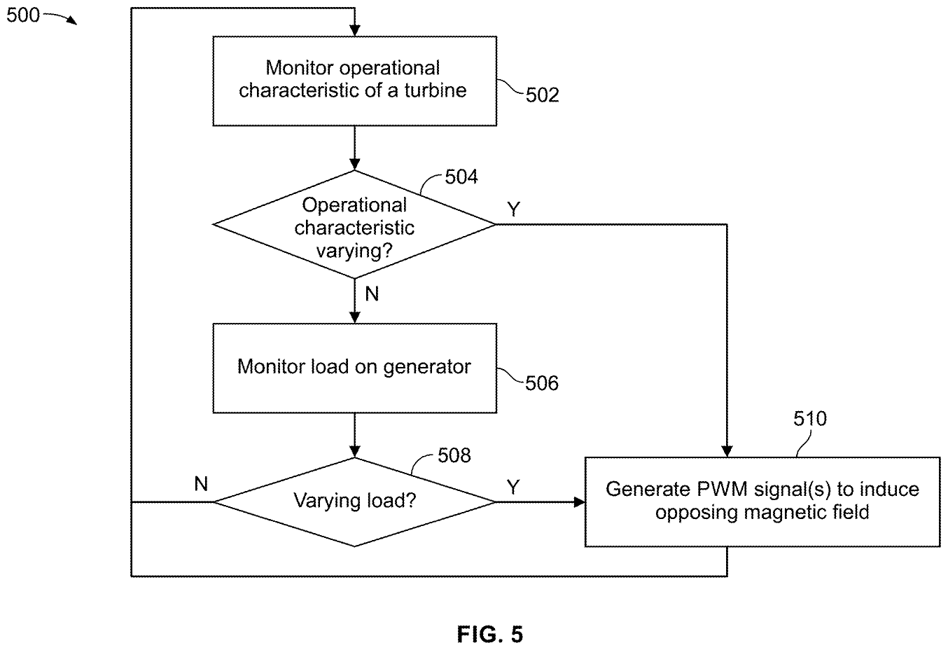

FIG. 5 illustrates a flowchart of one example method 500 for controlling a rotary machine. The method 500 can represent operations performed by the control circuit and/or controller described herein to control the speed at which the rotary machine rotates. At 502, an operational characteristic of the turbine is monitored. The operational characteristic may be monitored to determine the rate or speed at which fluid flowing through the turbine and/or the pressure of the fluid flowing through the turbine. For example, the output voltage generated by the generator can be monitored such that, if the voltage increases, then the rotational speed is determined to increase and if the voltage decreases, then the rotational speed is determined to decrease. The electric current output by the generator can be monitored such that, if the current increases, then the rotational speed is determined to increase and if the current decreases, then the rotational speed is determined to decrease. If the electric current that is conducted within one or more coils of the generator increases, then the rotational speed is determined to increase. If the electric current that is conducted within one or more coils of the generator decreases, then the rotational speed is determined to decrease.

At 504, a determination is made as to whether the value of the operational characteristic is varying. For example, the controller can determine whether the operational characteristic is increasing or decreasing. The controller can determine that a change in the operational characteristic indicates that the flow of the fluid is changing. If the operational characteristic changes by more than a threshold amount, is changing to exceed or fall below a threshold, is changing at a rate that exceeds a threshold rate, or the like, then the controller may determine that rotation of the turbine may need to be limited to prevent an overspeed event due to changing fluid flow. As a result, flow of the method can proceed toward 510. But, if the operational characteristic is not changing by more than the threshold amount, is not changing to exceed or fall below the threshold, is not changing at a rate that exceeds the threshold rate, or the like, then the controller may determine that rotation of the turbine may not need to be limited to prevent an overspeed event due to the changing operational characteristic. As a result, flow of the method can proceed toward 506.

At 506, a load placed on the generator is monitored. The load may be monitored to determine whether the demand for current placed on the generator is changing. For example, the controller can communicate with the loads to determine whether the number of active loads demanding current has changed, whether an operational state of the loads has changed, etc.

At 508, a determination is made as to whether the load demand on the generator is varying. For example, the controller can determine whether the load is decreasing. If the load is decreasing by more than a threshold amount, is changing to fall below a threshold, is decreasing at a rate that exceeds a threshold rate, or the like, then the controller may determine that rotation of the turbine may need to be restricted to prevent generating too much current for the load(s). As a result, flow of the method can proceed toward 510. But, if the load is not decreasing by more than the threshold amount, is not decreasing below the threshold, is not decreasing at a rate that exceeds the threshold rate, or the like, then the controller may determine that rotation of the turbine may not need to be limited to prevent an overspeed event. As a result, flow of the method can return toward 502. The method can proceed in a loop-wise manner to continue monitoring fluid flow and/or loads, or may terminate.

In one embodiment, the operations of monitoring the load placed on the generator (at 506) and/or determining whether the demanded load is varying (at 508) are not performed as part of the method. For example, if the operational characteristic of the turbine is monitored (at 502) and the determination of whether the value of the operational characteristic is varying is completed (at 504), then the method may not include monitoring the load placed on the generator (at 506) and/or determining whether the demanded load is varying (at 508). Optionally, the operations of monitoring the operational characteristic of the turbine (at 502) and/or determining whether the value of the operational characteristic is varying is completed (at 504) are not performed as part of the method. For example, if the load placed on the generator is monitored (at 506) and/or the determination of whether the demanded load is varying is made (at 508), then the method may not include monitoring the operational characteristic of the turbine (at 502) and/or determining whether the value of the operational characteristic is varying (at 504).

At 510, control signals are generated to induce a magnetic field in the generator that opposes rotation of the turbine by the fluid flow. For example, control signals are applied to one or more switches in the control circuit to temporarily induce an opposing magnetic field that slows rotation of the rotor and turbine. This can help keep the rotation of the turbine to within a defined window or range of speeds and prevent undue wear and tear on the turbine. The method can return toward 502 in a loop-wise manner to continue monitoring fluid flow and/or loads, or may terminate.

One example method described herein includes determining one or more operational characteristics of the rotary machine. The rotary machine generates electric current from flow of the fluid through the rotary machine. The method also includes applying control signals to the rotary machine to alternate between (a) coupling one or more outputs of the rotary machine to a ground reference or to another output of the rotary machine (e.g., a positive rail) and (b) disconnecting the one or more outputs of the rotary machine from the ground reference or to another output of the rotary machine (e.g., the positive rail) based on the control signals. The control signals control a speed at which the rotary machine operates during changes in the one or more of the varying flow of the fluid through the rotary machine and/or the varying load placed on the rotary machine.

Optionally, the method also includes detecting the electric current generated by the rotary machine and changing the control signals based on the electric current generated by the rotary machine.

The speed at which the rotary machine operates can be the speed at which a rotor of the rotary machine rotates. The method also can include detecting the speed at which the rotor is rotating and changing the control signals based on the speed at which the rotor is rotating.

Optionally, one or more of a duty cycle and/or a period (e.g., time period) of the control signals that are applied to the rotary machine can be controlled based on the one or more of the varying flow of the fluid through the rotary machine or the varying load placed on the rotary machine.

The control signals can control the speed at which the rotary machine operates to within a predefined range of speeds independent of the one or more of the varying flow of the fluid through the rotary machine and/or the varying load placed on the rotary machine.

Optionally, the method also includes detecting an overspeed event of the rotary machine responsive to the speed of the rotary machine exceeding a designated threshold. The control signals can be applied responsive to the overspeed event being detected.

One example of a rotary machine described herein includes a stator including one or more outputs and a rotor that rotates relative to the stator in response to flow of a fluid by or through the rotor. Rotation of the rotor relative to the stator induces an electric current that is conducted via the one or more outputs. The rotary machine also includes a control circuit configured to determine one or more of a flow of the fluid, a speed of the fluid, a voltage of the rotary machine, or a load placed on the rotary machine for the electric current. The control circuit is configured to apply control signals via switches to the one or more outputs of the stator to alternate between (a) coupling the one or more outputs of the rotary machine to a ground reference or to another output of the rotary machine and (b) disconnecting the one or more outputs of the rotary machine from the ground reference or to another output of the rotary machine based on the control signals. The control signals control a speed at which the rotor rotates independent of the one or more of the varying flow of the fluid through the rotary machine or the varying load placed on the rotary machine.

The control circuit can control the speed at which the rotor rotates by applying the control signals that direct the electric current induced in the stator to be conducted into the control circuit. The control circuit can include one or more switches connected with the one or more outputs of the stator. The control signals induce a magnetic field between the rotor and the stator that resists a force imparted on the rotor by the fluid. The control circuit can be configured to apply the control signals to the one or more switches to couple the one or more outputs of the stator to the ground reference or to each other.

The control circuit can be configured to detect the electric current output from the stator and to change the control signals based on the electric current that is output from the stator. The control circuit can be configured to detect the speed at which the rotor is rotating and to change the control signals based on the speed at which the rotor is rotating.

The control circuit can be configured to change one or more of a duty cycle or a period of the control signals based on the one or more of the varying flow of the fluid through the rotary machine or the varying load placed on the rotary machine. The control circuit may be configured to generate the control signals to maintain the speed at which the rotor rotates to within a predefined range of speeds independent of the one or more of the varying flow of the fluid through the rotary machine or the varying load placed on the rotary machine. Optionally, the control circuit can be configured to detect an overspeed event of the rotor and to apply the control signals responsive to the overspeed event being detected.

One example of a power generator system described herein includes a rotary machine including a rotor that rotates and generates electric current in response to flow of a fluid by or through the rotor. The rotary machine includes phased outputs that conductively coupled the rotary machine to one or more loads for supplying the electric current to power the one or more loads. The system also includes a control circuit configured to determine one or more of a flow of the fluid, a speed of the fluid, a voltage generated by the rotary machine, and/or a current demand placed on the rotary machine by the one or more loads. The control circuit is configured to apply control signals to switches, which induces extra or additional current. This extra or additional current induces an opposing magnetic field in the rotary machine that resists rotation of the rotor to control a speed at which the rotor rotates independent of the one or more of the varying flow of the fluid through the rotary machine or the varying load placed on the rotary machine.

The rotary machine can be a turbine disposed onboard a vehicle system. Optionally, the turbine can be disposed onboard a rail vehicle system and the one or more loads include an end-of-train device onboard the rail vehicle system. The rotor can be configured to rotate and generate the electric current in response to flow of one or more of air, water, steam, liquid, or engine exhaust.

Optionally, the rotor is coupled with a propeller of a marine vessel.

Optionally, the rotor is rotated by the flow of oil in a conduit of a vehicle.

Optionally, the rotor is rotated by the flow of exhaust from an engine of a vehicle.

Optionally, the one or more loads include a hand-held power tool.

One example of a control system described herein includes a rotary machine that one or more of generates propulsive force to propel a vehicle or a braking effort to slow movement of the vehicle. The rotary machine includes a rotor and a stator having conductive coils for conduction of different phases of electric current. The control system also includes a controller coupled with the rotary machine and configured to apply control signals to one or more switches coupled with one or more of the coils of the stator. The control signals induce a temporary magnetic field between the rotor and the stator that resists rotation of the rotor relative to the stator.

Optionally, the rotary machine includes a traction motor of a vehicle, and the controller can be configured to generate a braking effort of the vehicle by applying the control signals to resist rotation of the traction motor.

Optionally, the rotary machine includes a wind turbine and the controller can be configured to apply the control signals to extend a permissible operating speed of the wind turbine without changing gearing or an orientation of blades of the wind turbine.

Optionally, the rotary machine includes a turbine onboard an aircraft and the controller can be configured to apply the control signals to slow movement of the aircraft.

Optionally, the rotary machine includes a turbine onboard an aircraft, and the turbine can be controlled to generate propulsion of the aircraft. The controller can be configured to apply the control signals to maintain a rotating speed of the rotor of the turbine during varying flow conditions of air through the turbine.

As one example, a method includes determining one or more operational characteristics of a generator that is coupled with a rotary machine and that generates electric energy from flow of fluid through the rotary machine. The method also includes applying control signals to control one or more switches of the rotary machine to induce a magnetic field in the rotary machine that resists a force imparted on a rotor of the rotary machine from the flow of the fluid. The control signals control the one or more switches of the rotary machine to control operation of the rotary machine and effect a change in the one or more operational characteristics.

The control signals can be PWM signals. The control signals can be applied to one or more switches that couple the one or more outputs of the rotary machine to the ground reference, to a positive supply (e.g., a source or supply of a positive potential), or to each other. The method optionally also includes changing the control signals based on the one or more operational characteristics of the rotary machine.

The one or more operational characteristics can include the speed at which a rotor of the rotary machine rotates. The method also can include detecting the speed at which the rotor is rotating and changing the control signals based on the speed at which the rotor is rotating.

One or more of a duration, duty cycle or a period of the control signals that are applied to the one or more switches of the rotary machine can be controlled based on a change in the one or more operational characteristics. The control signals can control the speed at which the rotary machine operates to within a predefined range of speeds. The predefined range of speeds can change with respect to time.

The method also may include detecting an overspeed event of the rotary machine responsive to the speed of the rotary machine exceeding a designated threshold, where the control signals are applied responsive to the overspeed event being detected.

As another example, a rotary machine includes a stator and a rotor that rotates relative to the stator in response to flow of a fluid by or through the rotor. Rotation of the rotor relative to the stator induces an electric current that is conducted via the one or more stator windings. The rotary machine also includes a control circuit configured to determine one or more operational characteristics of the electric machine. The one or more operational characteristics are indicative of a flow of the fluid or a load placed on the rotary machine, the control circuit configured to apply control signals to control one or more switches of the rotary machine to induce a magnetic field in the rotary machine that resists a force imparted on a rotor of the rotary machine from the flow of the fluid. The control signals control the one or more switches of the rotary machine to control a speed at which the rotor rotates.

The control circuit can be configured to apply the control signals to the one or more switches to couple the one or more outputs of the stator to the ground reference, a positive supply, or to each other. The control circuit can be configured to change the control signals based on an electric monitored operational parameter. The control circuit can be configured to change the control signals based on one or more of the speed at which the rotor is rotating or a load demand placed on the rotary machine. The control circuit can be configured to change one or more of a pulse width, duty cycle or a period of the control signals based on a change in the one or more operational characteristics.

The control circuit can be configured to generate the control signals to maintain the speed at which the rotor rotates to within a predefined range of speeds. The predefined range of speeds can change with respect to time. The control circuit can be configured to detect an overspeed event of the rotor and to apply the control signals responsive to the overspeed event being detected.

In another example, a power generator system includes a rotary machine including a rotor and a stator that generates electric current in response to flow of a fluid by or through the rotor. The rotary machine includes phased outputs that conductively coupled the rotary machine to one or more loads for supplying the electric current to power the one or more loads. The system also includes a control circuit configured to determine one or more of a varying flow of the fluid or a varying current demand placed on the rotary machine by the one or more loads. The control circuit is configured to apply control signals to one or more switches of the rotary machine to induce a magnetic field in the rotary machine that resists rotation of the rotor to control a speed at which the rotor rotates independent of the one or more of the varying flow of the fluid through the rotary machine or the varying load placed on the rotary machine.

The rotary machine can be a turbine disposed onboard a vehicle system. The turbine can be disposed onboard a rail vehicle system and the one or more loads include an end-of-train device onboard the rail vehicle system. The rotor can be configured to rotate and generate the electric current in response to flow of one or more of air, water, steam, liquid, or engine exhaust.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
determining one or more operational characteristics of a generator that is coupled with a rotary machine and that generates electric energy from flow of fluid through the rotary machine; and
applying control signals to control one or more switches of the rotary machine to induce a magnetic field in the rotary machine that resists a force imparted on a rotor of the rotary machine from the flow of the fluid,
wherein the control signals control the one or more switches of the rotary machine to control operation of the rotary machine and effect a change in the one or more operational characteristics.

2. The method of claim 1, wherein the control signals are applied to one or more switches that couple the one or more outputs of the rotary machine to the ground reference, to positive supply, or to each other.

3. The method of claim 1, further comprising:
changing the control signals based on the one or more operational characteristics of the rotary machine.

4. The method of claim 1, wherein the one or more operational characteristics include the speed at which a rotor of the rotary machine rotates, and the method also can include:
detecting the speed at which the rotor is rotating; and
changing the control signals based on the speed at which the rotor is rotating.

5. The method of claim 1, wherein one or more of a duration, duty cycle or a period of the control signals that are applied to the one or more switches of the rotary machine are controlled based on a change in the one or more operational characteristics.

6. The method of claim 1, wherein the control signals control the speed at which the rotary machine operates to within a predefined range of speeds.

7. The method of claim 6, wherein the predefined range of speeds changes with respect to time.

8. The method of claim 1, further comprising:
detecting an overspeed event of the rotary machine responsive to the speed of the rotary machine exceeding a designated threshold,
wherein the control signals are applied responsive to the overspeed event being detected.

9. A rotary machine comprising:
a stator;
a rotor that rotates relative to the stator in response to flow of a fluid by or through the rotor, wherein rotation of the rotor relative to the stator induces an electric current that is conducted via the one or more stator windings; and
a control circuit configured to determine one or more operational characteristics of the electric machine, the one or more operational characteristics indicative of a flow of the fluid or a load placed on the rotary machine, the control circuit configured to apply control signals to control one or more switches of the rotary machine to induce a magnetic field in the rotary machine that resists a force imparted on a rotor of the rotary machine from the flow of the fluid,
the control signals controlling the one or more switches of the rotary machine to control a speed at which the rotor rotates.

10. The rotary machine of claim 9, wherein the control circuit is configured to apply the control signals to the one or more switches to couple the one or more outputs of the stator to the ground reference, a positive supply, or to each other.

11. The rotary machine of claim 9, wherein the control circuit is configured to change the control signals based on an electric monitored operational parameter.

12. The rotary machine of claim 9, wherein the control circuit is configured to change the control signals based on one or more of the speed at which the rotor is rotating or a load demand placed on the rotary machine.

13. The rotary machine of claim 9, wherein the control circuit is configured to change one or more of a pulse width, duty cycle or a period of the control signals based on a change in the one or more operational characteristics.

14. The rotary machine of claim 9, wherein the control circuit is configured to generate the control signals to maintain the speed at which the rotor rotates to within a predefined range of speeds.

15. The rotary machine of claim 14, wherein the predefined range of speeds changes with respect to time.

16. The rotary machine of claim 9, wherein the control circuit is configured to detect an overspeed event of the rotor and to apply the control signals responsive to the overspeed event being detected.

17. A power generator system comprising:
a rotary machine including a rotor and a stator that generates electric current in response to flow of a fluid by or through the rotor, the rotary machine including phased outputs that conductively coupled the rotary machine to one or more loads for supplying the electric current to power the one or more loads; and
a control circuit configured to determine one or more of a varying flow of the fluid or a varying current demand placed on the rotary machine by the one or more loads, the control circuit configured to apply control signals to one or more switches of the rotary machine, inducing a magnetic field in the rotary machine that resists rotation of the rotor to control a speed at which the rotor rotates independent of the one or more of the varying flow of the fluid through the rotary machine or the varying load placed on the rotary machine.

18. The power generator system of claim 17, wherein the rotary machine is a turbine disposed onboard a vehicle system.

19. The power generator system of claim 18, wherein the turbine is disposed onboard a rail vehicle system and the one or more loads include an end-of-train device onboard the rail vehicle system.

20. The power generator system of claim 17, wherein the rotor is configured to rotate and generate the electric current in response to flow of one or more of air, water, steam, liquid, or engine exhaust.
